(19) United States
(12) Patent Application Publication
(10) Pub. No.: US 2010/0001057 A1
(43) Pub. Date: Jan. 7, 2010

(54) System for Infrastructure-Supported Toll Collection Using an On-Board Unit that is Intergrated in the Vehicle

(76) Inventors: Katja Huelbusch, Holle (DE); Werner Poechmueller, Hildesheim (DE)

Correspondence Address: KENYON & KENYON LLP, ONE BROADWAY, NEW YORK, NY, 10004, US

(21) Appl. No.: 11/992,207

(22) PCT Filed: Oct. 4, 2006
(86) PCT No.: PCT/EP2006/067018

§ 371 Date: Aug. 31, 2009

(30) Foreign Application Priority Data
Oct. 10, 2005 (DE) 102005048351.8

(51) Int. Cl. G07B 15/00

(52) U.S. Cl. 235/29 R

(57) ABSTRACT

In a system for infrastructure-supported toll collection using an on-board unit that is integrated in the vehicle, at least one of the subfunctions that is not designed to be tamperproof is situated in another unit that in turn is connected via an interface with the on-board unit, which on-board unit includes the core function designed to be tamperproof, and communicates with it via a standardized message catalog.

### BACKGROUND OF THE INVENTION

1. Field of the Invention

The present invention relates to a system for facilitating infrastructure-supported toll collection using an on-board unit integrated in a vehicle.

2. Description of Related Art

The GPS-supported truck toll system with automatic route entry that is used in Germany is known. In this connection, the automatic route entry is carried out by a toll-collection terminal called an on-board unit that is installed as a separate unit on or in the instrument panels of trucks and put into operation by an authorized workshop. Various on-board units are known. The on-board units are usually lead-sealed and must satisfy high security requirements. For example, tamper-proofness may be guaranteed by a self-destruction mechanism that is activated when the housing of the on-board unit is opened without authorization.

In Germany, for example, on-board units are used that have a receiver for the GPS satellite positioning system with which the position of the vehicle is able to be determined. Furthermore, a mobile radio transmitter/receiver and a memory containing vehicle-specific information and the position data of all German toll express motor roads are built in. Using this data and the GPS signal, the on-board unit calculates during the drive the toll due and stores this in a data packet. Once a predetermined data volume has been reached, this packet is sent in the form of an SMS via GSM mobile radio communication to the operator's central computer. The present invention is not restricted to a specific embodiment of the on-board unit.

There are on-board units that are installed behind the windshield as preprogrammed units and that may be operated by two buttons. Others are made up of two parts, to wit, a small infrared transponder that is situated behind the windshield and an on-board computer that is inserted into the standardized module rack in the instrument panel of the truck.

### A BRIEF SUMMARY OF THE INVENTION

The present invention separates from the core function of the on-board unit at least one of the subfunctions assigned to the on-board unit that does not have to be designed in a tamperproof manner and to relocate it to another unit and to connect the latter, via a preferably standardized interface, to the on-board unit, which includes the core function and is designed to be tamperproof.

Thus, the system according to the present invention is made up of a first tamperproof, preferably standardized subsystem in the form of the on-board unit and a second, non-standardized, freely-definable subsystem in the form of the other unit.

According to the present invention, the communication between the other unit and the on-board unit takes place via a message catalog that is preferably standardized. This message catalog includes the subfunctions that do not have to be designed in a tamperproof manner, preferably control functions, diagnosis functions, power-management functions, functions for downloading and updating software, and/or position-finding functions.

For example, the other unit may be a driver information system (DIS) that is known in different embodiments for different vehicle types. The driver information system (DIS) bundles numerous individual displays and, in a central location, informs the driver about everything that is important. It is usually easy to operate and clearly laid out. For example, the driver information system (DIS) may include the on-board computer, the auto-check control, the door and baggage-compartment lid warning, the radio channel name or frequency, the outside temperature display with a slipperiness warning, a speed warning, or navigation directions. In addition, the other unit may also be a car radio, a cockpit instrument, a PDA, a pocket PC, a handheld, or an organizer. Of course, every other preferably mobile consumer device may also be considered as the other unit.

The separation of the at least one subfunction has different advantages.

First, the separation results in material savings and thus cost savings since different components that relate to the at least one subfunction are no longer required in the on-board unit and usually already exist in the other unit. According to the present invention, the on-board unit and the other unit then share these components.

Due to the fact that components are dispensed with in the on-board unit, the on-board unit may have smaller dimensions. It may then be more easily integrated in the vehicle since less installation space is required in the vehicle.

The shared use of existing components by the on-board unit and the other unit also increases the quality of the system since on the one hand no additional soldering points and on the other hand not much more software are required.

Preferably the on-board unit's HMI (human machine interface) is transferred to the other unit. In this manner, the on-board unit may be integrated in the vehicle in a particularly attractive manner. For then the on-board unit no longer has to be directly accessible and may be installed virtually anywhere in the vehicle, in the trunk, dashboard, or in a module rack, for example.

The device diagnosis of the on-board unit, in particular the temporary storage of device states or errors, may advantageously be performed at least in part by the other unit. In this instance, the CAN network of the vehicle may be accessed via the driver information system, for example.

Voltage may also be supplied to the on-board unit via the other unit, in particular via the driver information system. In this manner, a separate power supply unit in the on-board unit may be omitted.

The on-board units are preferably standardized in such a way that they may be connected without problems to other units of different manufacturers.

### A BRIEF DESCRIPTION OF THE DRAWING

FIG. 1 shows a block diagram of a system for infrastructure-supported toll collection.

### DETAILED DESCRIPTION OF THE INVENTION

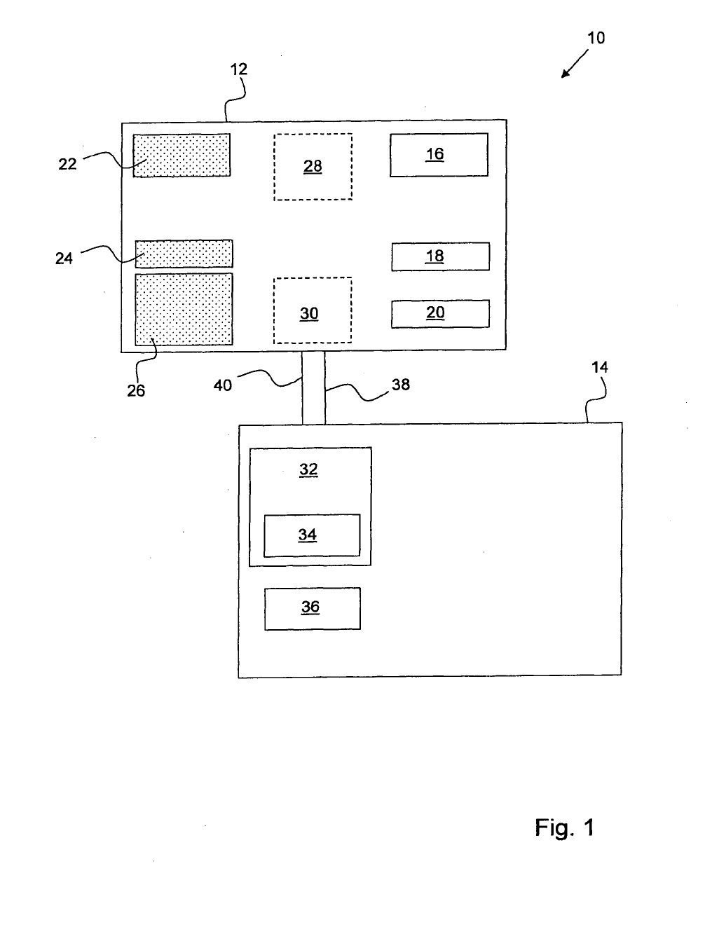

System 10, shown in FIG. 1, for infrastructure-supported toll collection includes an on-board unit 12 that is integrated into the vehicle and another unit 14 in the form of a driver information system.

On-board unit 12 includes a receiver 16 for the GPS satellite positioning system, with which the position of the vehicle may be determined at any time, a mobile radio transmitter/receiver 18 and a memory not shown here, in which vehicle-specific information and the position data of all German toll express motor roads are contained. Using these data and the GPS signal, the on-board unit calculates during the drive the toll due and stores it in a data packet. Once a predetermined data volume has been reached, this data packet is sent, in the form of an SMS, via GSM mobile radio communication to the operator's central computer, not shown here.

Furthermore, on-board unit 12 includes a DSRC module 20 (Dedicated Short Range Communication) that is normally mounted on the windshield of the vehicle and used for communicating with toll bridges or mobile toll vehicles, for example.

Furthermore, on-board unit 12 includes a CAN interface 22, a power supply unit 24, and an HMI having a display 26 for control purposes.

Finally, on-board unit 12 additionally contains a module for diagnosis 28 and software 30 required for operating on-board unit 12.

The other unit 14 in the form of a driver information system includes an HMI 32 having a display 34 and other components 36 that depend on the type of unit 14 and do not require a more detailed explanation here. For example, unit 14 additionally includes a CAN bus, not shown here, via which the other unit 14 is able to exchange data with other units connected to the CAN network.

On-board unit 12 and the other unit 14 are connected to each other via a communication line 38. An additional line 40 coming from the other unit 14 may be used to supply power to the on-board unit.

In FIG. 1, components that may be completely replaced in on-board unit 12 by communication with corresponding components in the other unit 14 are illustrated by a dotted filling. Components that may be partially replaced are illustrated by dashed borders. On the other hand, the components illustrated with solid borders must remain in on-board unit 12, which is designed to be tamperproof.

Of course, on-board unit 12 shown in FIG. 1 is only one possible embodiment. Other embodiments of on-board unit 12 are also possible. This being the case, naturally the present invention is not restricted to the embodiment of on-board unit 12 shown in FIG. 1.

1-11. (canceled)

11. A system for facilitating infrastructure-supported toll collection, comprising:
an on-board unit integrated in a vehicle, wherein the on-board unit includes at least one core functionality of the system configured to be tamper-proof; and
a second unit connected to the on-board unit via an interface, wherein the second unit includes at least one functionality of the system not configured to be tamperproof, and wherein the second unit communicates with the on-board unit via a standardized message catalog.

12. The system as recited in claim 12, wherein the message catalog includes at least one of: a) control functions; b) diagnosis functions; c) power-management functions; d) functions for downloading and updating software; and e) position-finding functions.

13. The system as recited in claim 13, wherein the second unit is not standardized and is freely defined.

14. The system as recited in claim 12, wherein the second unit is one of a driver information system, a car radio, a cockpit instrument, a PDA, a pocket PC, a handheld, or an electronic organizer.

15. The system as recited in claim 14, wherein the on-board unit is connected to the second unit one of wirelessly or via an external line.

16. The system as recited in claim 14, wherein the on-board unit is integrated as a module in the housing of the second unit, and wherein communication between the on-board unit and the second unit takes place via an internal bus.

17. The system as recited in claim 14, wherein the on-board unit is configured to provide location data used by the second unit.

18. The system as recited in claim 14, wherein the second unit is configured to exchange data with additional units that are integrated in the vehicle, wherein the exchange of data takes place via one of CAN or Flexray.

19. The system as recited in claim 14, wherein the second unit provides at least one of voltage supply and position-finding functionality for the on-board unit.

20. The system as recited in claim 14, wherein the at least one functionality of the system not configured to be tamperproof includes at least one of: a) control of one of haptic or acoustic input; b) control of one of graphic or acoustic output; c) at least a portion of device diagnosis, including temporary storage of one of device states or errors; and d) implementation of a software update via a vehicle bus configured as CAN or Flexray.
